(19) United States
(12) Patent Application Publication
(10) Pub. No.: US 2006/0243279 A1
(43) Pub. Date: Nov. 2, 2006

(54) SCENTED ANESTHESIA BREATHING CIRCUIT

(76) Inventor: Allen J. Hinkle, Lebanon, NH (US)

Correspondence Address: MICHAEL J. WEINS, 31 BANK STREET, LEBANON, NH, 03766, US

(21) Appl. No.: 11/457,624

(22) Filed: Jul. 14, 2006

Related U.S. Application Data
(63) Continuation-in-part of application No. 10/904,930, filed on Dec. 6, 2004, now abandoned.

(51) Int. Cl. F16K 31/02

(52) U.S. Cl. 128/204.22

(57) ABSTRACT

An anesthesia breathing circuit for connecting between an anesthesia delivery machine and a mask has an inspiratory tube, an expiratory tube, and a connection that allows the mask to communicate with both the inspiratory tube and the expiratory tube. The present invention resides in using a material which incorporates a scent-releasing agent to fabricate at least one element of the breathing circuit through which gas is fed to the mask from the anesthesia delivery machine. In one preferred embodiment, the scented element is a segment that may be coupled to conventional elements of an anesthesia breathing circuit so as to form a part of the inspiratory tube; the scented element can then be uncoupled when the scent is no longer desired.

This application is a continuation-in-part of application Ser. No. 10/904,930, filed Dec. 6, 2004.

### BACKGROUND OF THE INVENTION

Classically, an anesthesia breathing circuit is employed for delivery of an anesthetic gas mixture from an anesthesia delivery machine to a patient, and for returning exhaled gases from the patient to the anesthesia delivery machine. The anesthesia breathing circuit is typically employed with a face mask that sealably covers the nose and mouth of the patient. An anesthesia breathing circuit has an inspiratory tube for delivery of gas from the anesthesia delivery machine to a patient, an expiratory tube for delivery of gases exhaled by the patient to the anesthesia delivery machine, and a means for connecting to the face mask so as to communicate between the face mask and the inspiratory tube and the expiratory tube.

The means for connecting connects to a single port on the face mask and communicates between this port and both the inspiratory tube and the expiratory tube. This configuration allows the anesthesia delivery machine to control the flow of gasses to and from the mask; in some situations, the anesthesia delivery machine has the ability to assist the patient in breathing while under anesthesia. The connection to a single port also makes the anesthesia breathing circuit suitable for use without a mask, which is sometimes preferable for pediatric patients who are apprehensive about having an object covering the face. The means for connecting frequently includes an elbow connecting between the face mask and the inspiratory and expiratory tubes. These elements have traditionally been formed as discrete elements, but could be formed either partially or entirely as an integral assembly to reduce or eliminate leakage between adjacent elements. One such integrated system is taught by U.S. Pat. No. 3,721,238.

The details of these anesthesia breathing circuits vary depending on the particular circuit selected. The circuits that are typically employed include circular circuits, where the inspiratory and expiratory tubes are separate and distinct, and Mapleson-type circuits, where the inspiratory tube terminates at or inside the expiratory tube. One commonly used variant of the Mapleson-type circuit is the Bain circuit, where a portion of the inspiratory tube resides within the expiratory tube. The Bain circuit has been further refined in the Universal F2 circuit offered by King Systems, where the inspiratory tube is completely housed within the expiratory tube and the partitioning of the inspiratory and expiratory gasses occurs in an anesthesia machine to which the expiratory and the inspiratory tube are connected.

One example of a Bain type anesthesia circuit 10 is illustrated in FIG. 1. The circuit 10 illustrated has an inspiratory tube 12 which terminates at a terminal region 14 of an expiratory tube 16, and is held in place by a centering element 18. The terminal region 14 serves as a connector piece and terminates in a collar 20 that is configured to attach to an elbow 22; in some embodiments, the centering element 18 may be formed integrally with the terminal region 14, which may includes the collar 20. The anesthesia circuit 10 serves to feed a face mask 24. The terminal region 14 and the elbow 22 provide means for connecting the face mask 24 to the inspiratory and expiratory tubes (12, 16); the elbow 22 may be optional if the terminal region 14 is sufficiently long and flexible. This Bain type anaesthesia circuit 10 attaches to an anesthesia machine 26 that regulates the supply of gas to the inspiratory tube 12 and from the expiratory tube 16. Such anesthesia circuits have the advantage that they only require a single tube leading to the mask and are more convenient for use where additional tubing could further reduce the access to the area where surgery is to be performed, such as during surgery on the head or on pediatric patients. However, such circuits typically require greater skill to be used effectively, as they require the fresh gas flow to be carefully adjusted to ensure that adequate fresh gas reaches the patient.

A circular anesthesia circuit 50 is illustrated in FIG. 2. It has separate tubes forming an inspiratory tube 52 and an expiratory tube 54. These tubes (52 and 54) feed separately into a Y-shaped connector piece 56 such as the connector pieces illustrated in the '238 patent, which in turn feeds an elbow 58. The anesthesia circuit 50 in turn feeds a mask 60. The circular anesthesia circuit 50 attaches to an anesthesia machine 62, which has connectors essentially similar to those of the anesthesia machine 22 shown in FIG. 1. The anesthesia machine 62 employed with the circular anesthesia circuit 50 has valves to control the flow of gas through the inspiratory tube 52 and the expiratory tube 54, and thus the circular anesthesia circuit 50 does not require stringent control of the fresh gas flow rate to avoid rebreathing of exhaled gasses.

Both types of circuits are currently in use, and for use with both types of circuits, the mask employed is frequently scented to block the pungent scent of the anesthetic gas used on the patient. The benefit of using a scented mask with an anesthesia breathing circuit is set forth in U.S. Pat. Nos. 4,896,666 and 6,779,524, while U.S. Pat. No. 5,109,839 teaches the use of a scented mask for use with a gas source to block the scent of anesthesia gas. The '666 patent is for the use of a mask in combination with a pacifier. The use of a pacifier has been found especially beneficial for pediatric use, as the pacifier makes the infant more at ease and reduces the pulse, which hastens the speed of anesthetic induction.

Since the masks are provided in different sizes and since various gasses may require different scents to effectively mask their pungent odors, a large inventory of masks must be maintained. While the inventory problem is, in part, addressed by the '524 patent where a scented sticker is applied to the mask, such is done at the costs of complicating the preparation of the anesthesia procedure as well as adding additional components which must be secured to the mask and which could create a hazard if they were to detach during use.

Another problem with using a scented mask, in particular for pediatric patients, is that such patients frequently have an apprehension of having the nose and mouth covered by the mask. To alleviate the apprehension, physicians frequently have the child suck on the circuit with the mask removed. While this eliminates the fear of the mask, the patient is subject to the pungent anesthesia gas.

Still a further problem with scented masks is that the scented agent continues to release the scent after the patient has been anesthetized, and the scent is no longer needed. The volatile agents typically used to release the scent may make the anesthetic gas less effective, thus requiring higher concentrations to be used, and may also interfere with some types of gas monitoring systems which are employed to adjust the composition of the anesthetic gas mix provided to the patient.

Thus, there is a need for an alternative system for blocking the pungent smell of anesthetic gases which is more cost effective and more convenient for use. There is also a need for a system which allows the scent to be readily reduced or eliminated when no longer providing a benefit to the patient.

### SUMMARY OF THE INVENTION

The present invention is for an anesthesia breathing circuit for use with a face mask. The anesthesia breathing circuit has an inspiratory tube, an expiratory tube, and a means for connecting to the face mask so as to communicate between the face mask and the inspiratory tube and the expiratory tube; this means frequently includes a connector and an elbow. The details of two examples of such anesthesia circuits currently in use are discussed in greater detail above. The improvement resides in using a material which incorporates a scent-releasing agent to fabricate at least one element of the breathing circuit through which gas is fed to the mask. This scented element can be either a segment or the entirety of the inspiratory tube and/or the means for connecting to the mask, or a portion thereof. In one preferred embodiment, the scented element is a segment that may be coupled to conventional elements of an anesthesia breathing circuit so as to form a part of the inspiratory tube. This allows the scented element to readily be uncoupled, either by diverting the gas flow or by removing the scented element, possibly by substituting a similar non-scented element, once the patient has been anesthetized and the scent is no longer needed.

By scenting a portion of the circuit through which gas flows toward the patient, transfer of the scent to the anesthesia gas is felt to be more efficient. It may be possible to use a lower concentration of scented compound to reduce the cost of fabrication compared to the cost of employing a scented mask, since the scent in a mask is released into dead air space and must diffuse through this space to mingle with the anesthesia gas mixture being fed to the patient, and thus it may require a relatively high concentration of the scented material to provide an effective concentration of scent.

Having a portion of the circuit scented according to the present invention, rather than the mask, also provide a benefit for a pediatric patient that has apprehension about having a mask placed over his/her nose and mouth, in that the invention allows the patient to avoid wearing a mask without subjecting the patient to a distasteful pungent gas.

Furthermore, by scenting selective segments of the circuit rather than the mask, it is possible to incorporate means for regulating and/or eliminating the scent as a function of time, thereby providing the benefit of scenting when a patient is initially placed under anesthesia, but eliminating the scent during the performance of the surgery. Thus, in a preferred embodiment, the circuit provides means for controlling the scent provided to the anesthesia gas. The following are examples of such means which appear to have particular utility.

In a preferred embodiment, a segment of the inspiratory tube is treated to provide the scent, this segment being configured to be insertable between a conventional inspiratory tube and an anesthesia machine. Preferably, the insertable segment terminates at a first connector configured to couple with the output coupling of the anaesthesia delivery machine and a second connector which is configured to match the connector of the output coupling of the anaesthesia delivery machine, thereby allowing the conventional inspiratory tube to be connected to the second connector.

It is further preferred that, when an insertable scented segment is provided which is configured to connect to the inspiratory tube, that this segment be corrugated to increase the area per unit length of the inspiratory tube, and thereby reduce the concentration of scent-releasing agent needed. This benefit is also present if a section of the inspiratory tube is scented; in the case of circular circuits using the standard corrugated tubing which is designed for flexibility without kinking.

When the scented element is a segment of the inspiratory tube that is formed of standard corrugated tubing, means for compressing the sidewalls of the corrugated surface into intimate contact can be provided to substantially suppress the scenting of the gas.

Treating such a segment of the inspiratory tube provides a benefit over the treatment of the other elements in that the surface of the inspiratory tube is not exposed to gases exhaled from the lungs of the patient. Thus, moisture or other by-products from the exhaled gas will not flow over the surface of the inspiratory tube; such moisture or by-products might reduce the effectiveness of the scented surface in transferring scent to the gas inspired by the patient.

### BRIEF DESCRIPTION OF THE FIGURES

FIG. 1 is view of a prior art Bain type anesthesia breathing circuit.

FIG. 2 is a view of a prior art circular anesthesia breathing circuit.

FIG. 3 is a view of an improved Bain type anesthesia breathing circuit showing the elements of the circuit illustrated in FIG. 1 that are subject to treatment with a scent-releasing agent to provide the improvement of the present invention.

FIG. 4 is a view of an improved circular anesthesia breathing circuit showing the elements of the circuit illustrated in FIG. 2 that are suitable for treatment to provide the improvement of the present invention.

FIG. 5 is a section view of a section of an inspiratory tube of the improved circuit shown in FIG. 4, having a section length L. This tube is corrugated to increase flexibility without promoting kinking of the tube that could interrupt flow.

FIGS. 6 and 7 illustrate an assembly to be used in combination with a scented length L of the inspiratory tube to provide means for controlling scent release. FIG. 6 illustrates the scented length L_{E} in its elongated state, where it releases scent to the anaesthesia gas passing therethrough, while FIG. 7 illustrates the scented length L collapsed to L_{C} so as to minimize scent release.

FIG. 8 illustrates an alternative means for collapsing the inspiratory tube segment shown in FIGS. 6 and 7. In this embodiment, a turnbuckle assembly engages the tube segment and can be adjusted to reduce the length of the segment.

FIGS. 9 through 11 illustrate an insertable segment of scented tubing having interfaces configured to slidably engage the connectors of the inspiratory port of the anesthesia machine and the standard coupling of the expiratory tube.

FIGS. 12 and 13 illustrate an insertable segment of scented tubing similar to that shown in FIGS. 9-11, which can be employed as a removable portion of the inspiratory tube. FIG. 12 shows the segment inserted in Bain type breathing circuit. FIG. 13 shows the segment inserted into a circular breathing circuit.

FIG. 14 illustrates a branch segment of scented tubing similar to that shown in FIGS. 12-13, which can be employed as a removable portion of the inspiratory tube to selectively provide scent for either a circular breathing circuit, as shown, or a Mapleson or Bain type breathing circuit. The branch segment includes a valve that allows the scent to be eliminated without requiring disconnection of the elements of the breathing circuit.

### DETAILED DESCRIPTION OF THE PREFERRED EMBODIMENTS

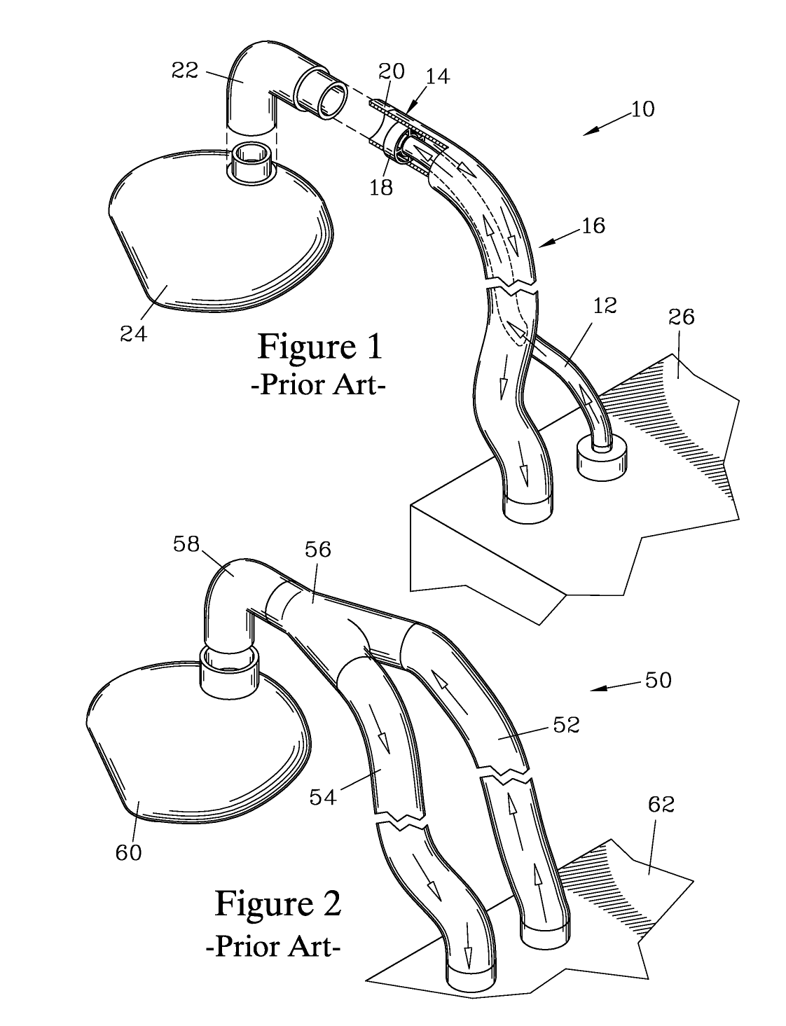

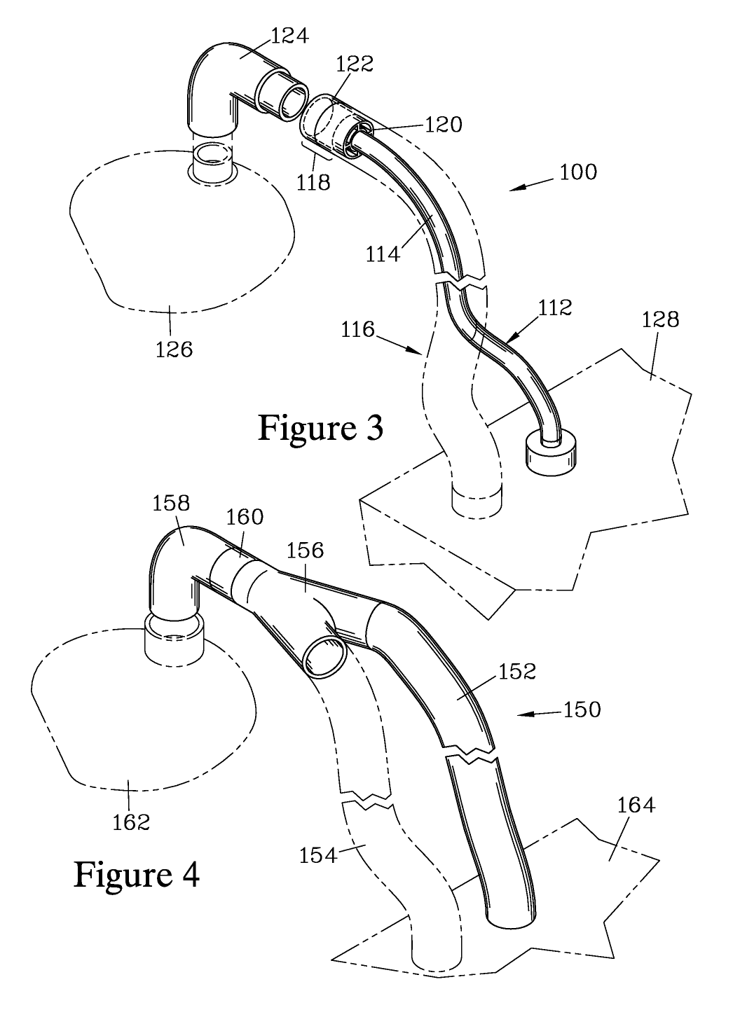

FIG. 3 is an illustration of a Bain type anesthesia circuit 100 of the present invention which has the same structural elements as the Bain type anesthesia circuit 10 illustrated in FIG. 1. The anesthesia circuit 100 has an inspiratory tube 112 having an internal segment 114 that resides within an expiratory tube 116 and is foreshorten such that it terminates at or before a terminal region 118 of the expiratory tube 116. The terminal region 118 may be either a continuation of the expiratory tube 116 or, alternatively, can be an attachment thereto.

The inspiratory tube 112 is held in place relative to the expiratory tube 116 by a centering element 120 to which the inspiratory tube 112 attaches. The centering element 120 shown frictionally engages the terminal region 118; in other embodiments, the centering element could be formed integrally with the terminal region 118. The terminal region 118 serves as a connector piece in this embodiment, and has a collar 122 that is configured to attach to an elbow 124. The elbow 124 is typically constructed from a rigid plastic; however, greater flexibility can be provided by employing a flexible elbow. The anesthesia circuit 100 in turn connects to a mask 126, allowing anesthesia gas from the internal segment 114 of the inspiratory tube 112 to flow into the mask 126 and expired gas from a patient (not shown) to flow from the mask 126 into the expiratory tube 116. The terminal region 118 of the expiratory tube 116 and the elbow 124 of this embodiment serve as means for connecting to the mask 126 so as to communicate between the mask 126 and the inspiratory tube 112 and the expiratory tube 116. Thus, in breathing circuits where a terminal region (such as the terminal region 118 shown in FIG. 3) of the expiratory tube extends beyond the end of the inspiratory tube, this terminal region is part of the means for connecting to the mask and the inspiratory tube and the expiratory tube.

The Bain type anaesthesia circuit 100 illustrated in FIG. 3 attaches to an anesthesia machine 128 that regulates the supply of gas to the inspiratory tube 112 and processes the gas from the expiratory tube 116. The improvement of the present invention is achieved by providing scent to the anesthesia circuit 100 by scenting one or more of the following elements of the anesthesia circuit 100: the inspiratory tube 112 or a part thereof, the terminal region 118 including the collar 122 (if the configuration of the circuit is such that the collar 122 has a significant exposed inner surface area when connected to the elbow), and the elbow 124. This can be accomplished by fabricating at least a portion of one or more of these elements from a material which incorporates a scent-releasing agent or by applying a scented coating thereto. Similar elements could be scented in other Mapleson type anesthesia circuits. The remaining elements illustrated in FIG. 3 (the remainder of the expiratory tube 116 and the mask 126) are shown in phantom, since these elements do not constitute part of the improvement of the present invention. While these elements could be scented, such would increase the cost of fabrication and, in the case of the mask, could prevent the possibility of reducing or eliminating the scent in the manner discussed in greater detail below.

In this embodiment, the inspiratory tube 112 passes through the expiratory tube 116 and is sheathed by it in the region near the mask 126 where kinking is most likely to occur, which limits the problem of having the inspiratory tube 112 kink so as to cut off flow. Thus, corrugation of the tubing used for the inspiratory tube 112 is not a necessity. However, corrugation of the inspiratory tube 112 will benefit the circuit, since it will increase the surface area per unit length and thus reduce the concentration of scent-releasing agent needed in the tubing to effectively block the pungent odor of the anesthesia gas.

FIG. 4 is an illustration of a circular anesthesia circuit 150 which is similar to the circular anesthesia circuit 50 illustrated in FIG. 2. The circular circuit 150 has separate tubes forming an inspiratory tube 152 and an expiratory tube 154. These tubes (152 and 154) feed separately into a Y-shaped connector piece 156, which in turn feeds an elbow 158 and is connected thereto by a collar 160 that can be a separate part or can be integral with either the Y-shaped connector piece 156 or the elbow 158. Typical examples of Y-shaped connectors are found in '238. The anesthesia circuit 150 in turn supplies anesthesia gasses to a mask 162. The Y-shaped connector piece 156, the collar 160, and the elbow 158 of this embodiment serve as means for connecting to the mask 162 so as to communicate between the mask 162 and the inspiratory tube 152 and the expiratory tube 154.

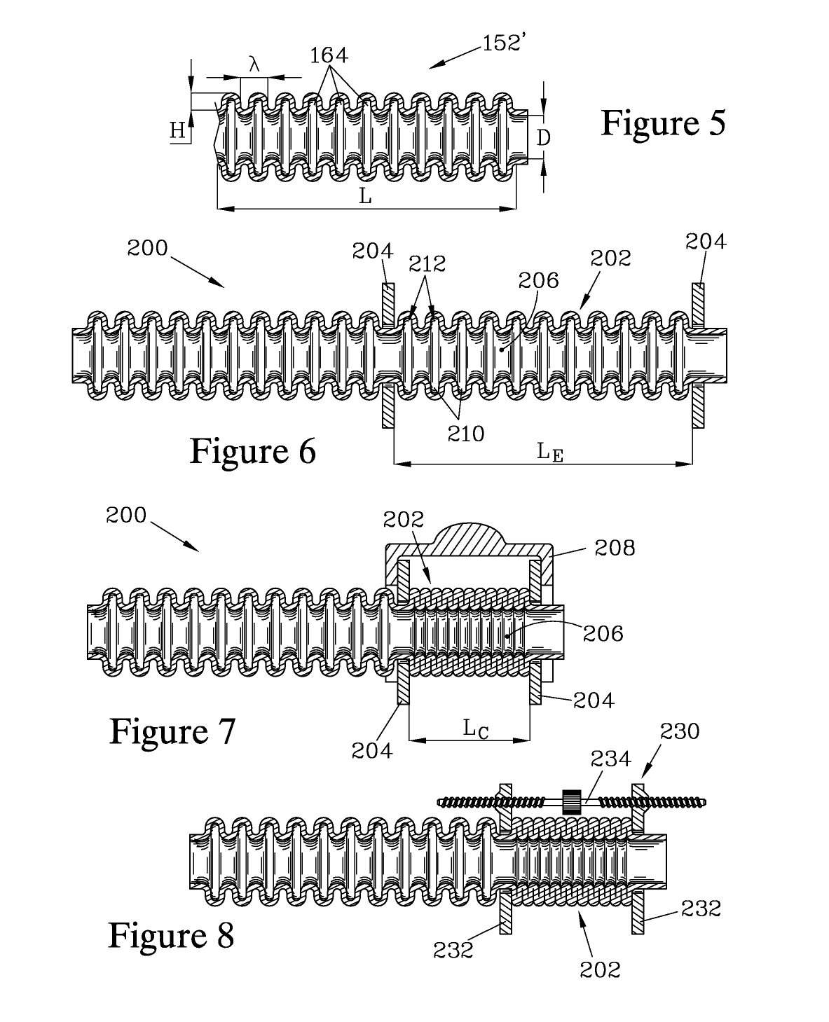

The circular anesthesia circuit 150 attaches to an anesthesia machine 164. The anesthesia machine 164 has internal valves (not shown) which regulate the flow through the inspiratory tube 152 and the expiratory tube 154 such that the inspiratory tube 152 will be fed anesthesia gas and, at the same time, a valve controlling flow in the expiratory tube 154 will be closed, thereby promoting flow of anaesthesia gas to the patient. Conversely, when the patient exhales, the valve controlling the flow in the inspiratory tube 152 is closed, blocking exhaled gas from traveling into inspiratory tube 152, while the valve in the expiratory tube 154 is open to allow expired gas to pass therethrough and into the asthenia machine 164. In this embodiment, it is preferred for the inspiratory tube 152 and the expiratory tube 154 to both be fabricated from corrugated tubing which increases flexibility while inhibiting kinking, as shown in FIG. 5 by the inspiratory tube 152′. Again, in the circular anesthesia circuit 150, the improvement of the present invention is achieved by providing scent to the anesthesia circuit 150 by scenting one or more of the inspiratory tube 152, the connector piece 156 and the elbow 158. The remaining elements of this embodiment are shown in phantom, including the mask 162, since these elements can be the same as the prior art elements. As discussed above, the invention has benefits independent of any particular details of these elements. In fact, the improved circuit can have benefit in the initiation of an anesthesia to a child without the use of a mask, as discussed above.

FIG. 5 shows a scented tubing segment of length L of the inspiratory tube 152′, illustrating details of the preferred corrugated structure, which is typically used to administer anesthesia. The length L illustrated in FIG. 5 is the neutral length of the segment, wherein the inspiratory tube 152′ is neither under a compressive load or a tensile load. The inspiratory tube 152′ typically has grooves 164 configured such that the ratio λ to H of the grooves 164 is in the neighborhood of about 1:1. This corrugated structure provides multiple benefits, one of which is to prevent kinking so that the flow will not be interrupted, as discussed above. The corrugations also increase the surface area of the inspiratory tube 152′ per unit length, and thus provide more surface contact with the anesthesia gas as it passes therethrough. In order for the corrugation to be effective, the grooves 164 of the corrugations should be relatively shallow so as not to create dead air spaces that will require the scent to diffuse therethrough. It is felt that the ratio of λ to H of the grooves 164 which is typically used in such tubing to avoid kinking should also serve to avoid dead spaces.

In the embodiments illustrated in FIGS. 3 and 4, there are multiple locations where the scent can be provided. However, if one were to scent only one of the elements, which could reduce costs and simplify manufacturing, a preferred element to form from a scented material would be the inspiratory tube or a segment thereof. The large surface area of this element, relative to the other elements that could be selected, should be likely to allow a lower concentration of scent-releasing agent to be used while still providing satisfactory performance.

A secondary advantage may arise from treating only the inspiratory tube or a section thereof. The scent so placed assures that, when gas flows over the scent-releasing surface, this flow is directed toward the mask, and thus all the entrained scent is advanced to the mask.

The ability to regulate the release of scent as a function of time is a great assistance in administering anesthesia to a patient. The use of scent is beneficial in reducing the distress of the patient when the gas is being administrated; however, the scent may also make the anesthesia less effective, which could require the use of higher concentration of the anesthesia gas. For this reason, it is preferred for the scent to be eliminated or greatly reduced once the patient has lost consciousness, thereby reducing the concentration of anesthesia needed. Additionally, the scent-releasing agent may interfere with accurate monitoring of the composition of the expired gases. Thus it is preferred to provide means for substantially reducing the transfer of scent from the scented portion of the circuit to the gas delivered to the patient. There are a variety of structural element that can be combined to proved means for reducing the transfer of scent to an anesthesia circuit. FIGS. 6-8 illustrate two embodiments where an adjustable length of a corrugated tube is employed as part of a means for reducing the transfer of scent to the anesthesia gas.

FIGS. 6 and 7 illustrate an inspiratory tube 200 which has a scented segment 202. The scented segment 202 is maintained between a pair of washers 204 that reside in a pair of spaced apart valleys that delineate the scented section 202 of the inspiratory tube 200, the washers serving as retaining elements. In FIG. 6, the scented segment 202 is in its unconstrained condition and has an elongated length L_{E} where it has a ribbed inner surface 206 over which the anesthesia gas flows. The elongated length L_{E} will frequently be the same as the neutral length L; however, the elongated length L_{E} may be sightly different if the inspiratory tube 200 is in use and is either slightly compressed or in tension. The scented section 202 is treated with the scent-releasing agent and, when in its unconstrained state (where it is at its elongated length L_{E}), the ribbed inner surface 206 transfers scent to the gas passing thereby. FIG. 7 illustrates the same tube 200; however, the scented segment 202 has been compressed to reduce or substantially eliminate the transfer of scent to the anesthesia gas. When the scent is to be reduced and, preferably, essentially eliminated, the elongated length L_{E} is collapsed to a collapsed length L_{C}, thereby reducing the scented region available for transfer of scent to the gas flowing through the inspiratory tube 200. Means for maintaining the scented segment 202 compressed are provided by a clip 208 that engages the washers 204 and constrains the washers 204 so as to limit their separation from each other. If the scent is to be substantially eliminated, it is preferred that only lower portions 210 (shown in FIG. 6) of grooves 212 that form the ribbed inner surface 206 be treated with the scent-releasing agent. If this is done, then collapsing the scented segment 202 essentially eliminates all the exposed scent-releasing regions. It should be noted that the scented segment 202 need not be the same diameter as the remainder of the inspiratory tube 200, and where it is desirable to reduce the length of the scented segment 202, such might be achieved by increasing the diameter to provide a greater surface area per unit length.

FIG. 8 illustrates a turnbuckle assembly 230 that can be employed in place of the washers 204 and clip 208 to reduce the length of the scented segment 202 shown in FIGS. 6 and 7 and discussed above. The turnbuckle assembly 230 has a pair of rings 232 that engage the scented segment 202 and serve as retaining elements. The rings 232 in turn are threadably engaged by a turnscrew 234. The turnscrew 234 has oppositely pitched threads such that it can be turned to force the rings 232 together, thereby compressing the scented segment 202 and providing means for maintaining the scented segment 202 compressed.

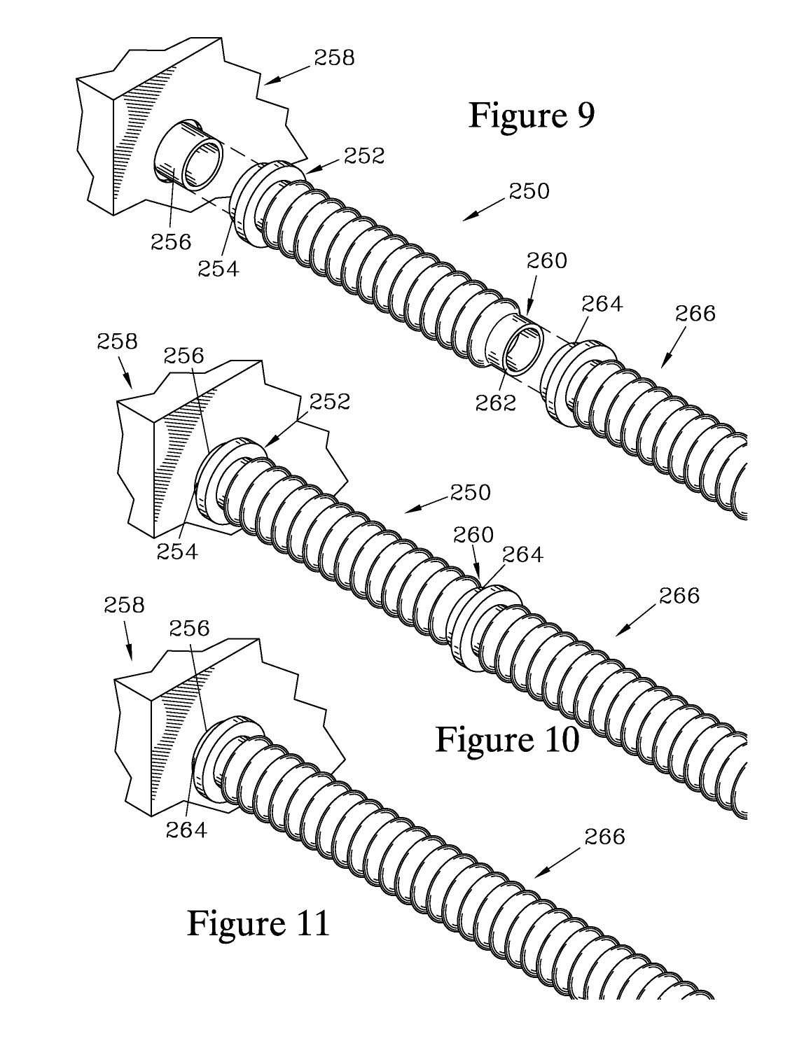

Another approach to reducing the transfer of scent and, in fact, eliminating the scent, is to make the scented portion of the circuit removable, so that it can be removed when the scent is no longer desired. Preferably, a portion of the inspiratory tube at or near the connection to the anesthesia delivery machine is made removable, to facilitate removal without requiring access in close proximity to the patient. FIGS. 9 and 10 illustrate an insertable tubing segment 250 terminating in a first end 252 which has a first end coupling 254 designed to sealably engage a standard anesthesia inspiratory port 256 of an anesthesia machine 258. In this embodiment, the first end coupling 254 and the standard anesthesia inspiratory port 256 are configured so that they can be forced together with a sliding action such that their overlapping surfaces form a seal. The scented tube 250 also terminates in a second end 260 which has a second end coupling 262 which is designed to sealably engage a standard inspiratory tube anaesthesia machine coupling 264 of an inspiratory tube 266. When interposed between the inspiratory tube 266 and the anesthesia machine 258 as shown in FIG. 10, the insertable tubing segment 250 essentially becomes a part of the inspiratory tube 266, forming a removable portion of the inspiratory tube, while the conventional inspiratory tube 266 forms a permanent portion.

The insertable tubing segment 250 allows the intermittent administration of scented anesthesia gas. The insertable tubing segment 250 is inserted when the anesthesia gas is first introduced and, after the patient has lost consciousness, the insertable tubing segment 250 can be removed from the circuit, and the standard inspiratory tube anaesthesia machine coupling 264 of the inspiratory tube 266 is connected directly to the standard anesthesia inspiratory port 256 of the anesthesia machine 258, as shown in FIG. 11. Removing the insertable tubing segment 250 when it is no longer needed eliminates the problem of continuous scenting of the anesthesia gas. The length and diameter of the insertable tubing segment 250 should be chosen to provide sufficient surface area for adequate transfer of scent while retaining the desired degree of flexibility of the insertable tubing segment 250. The insertable tubing segment 250 could alternatively be placed between the inspiratory tube 266 and a connector piece, but such placement may make removal of the insertable tubing segment 250 more difficult, since it would require access space close to the patient.

It should be noted that the scent could alternatively be reduced by collapsing the insertable tubing segment 250 and retaining it in such collapsed state, in the manner discussed above with regard to the scented segment 200 shown in FIGS. 6-8. This would allow reducing or substantially eliminating the scent without requiring the disconnection and reconnection of elements of the breathing circuit.

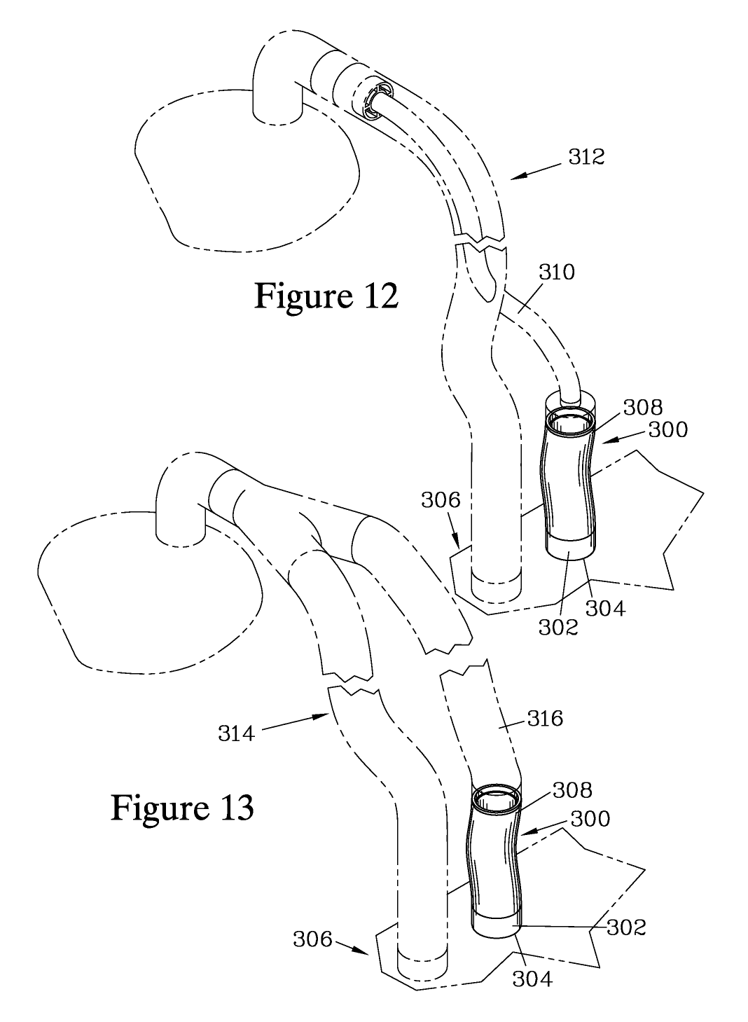

FIGS. 12 and 13 illustrate an insertable tubing segment 300 which is functionally similar to the insertable tubing segment 250 shown in FIGS. 9-11. The insertable tubing segment 300 again has a first end coupling 302 configured to be connected to a standard anesthesia inspiratory port 304 of an anesthesia machine 306, and a second end coupling 308 which has a configuration identical to that of the standard anesthesia inspiratory port 304. An inspiratory tube 310 of a Mapleson type anesthesia circuit 312 (a Bain circuit is illustrated in FIG. 12) can be connected to the second end coupling 308, when scent is desired, or directly to the standard anesthesia inspiratory port 304, when no scent is desired. Similarly, when a circular anesthesia circuit 314 is to be employed, an inspiratory tube 316 of the circular anesthesia circuit 314 can be connected to either the second end coupling 308, as shown in FIG. 13, or directly to the standard anesthesia inspiratory port 304. Thus, the insertable tubing segment 300 can be employed with either type of anesthesia circuit, simplifying the maintenance of inventory. As an alternative to removing the insertable tubing segment 300, it could be made collapsible to allow retaining the insertable tubing segment 300 in a collapsed state to reduce the release of scent.

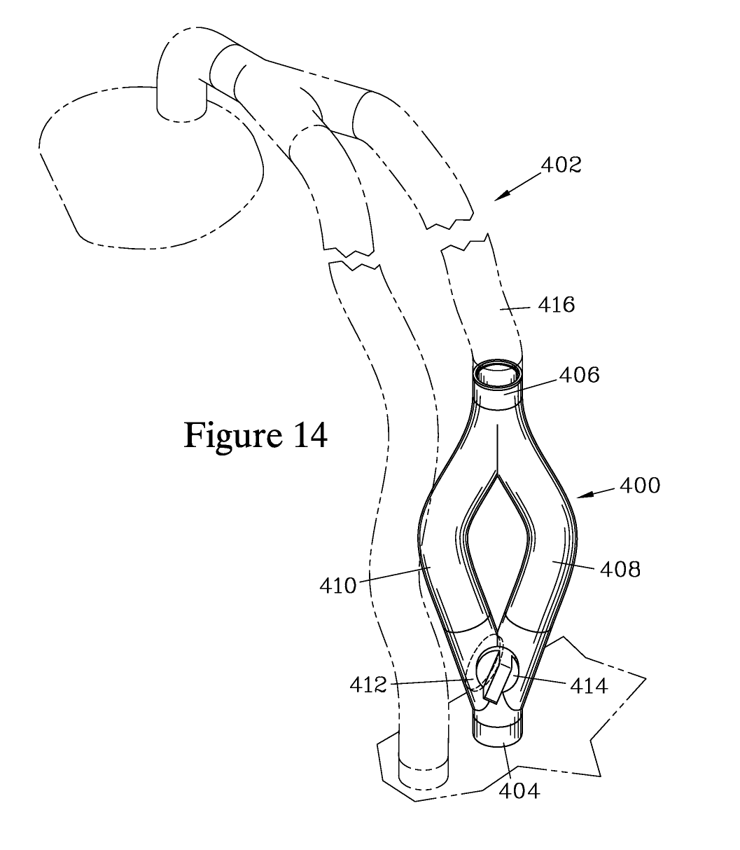

FIG. 14 illustrates a scented branched tubing segment 400 which can be employed in a manner similar to that of the insertable tubing segments 250 and 300 shown in FIGS. 9-13; however, the scented branched tubing segment 400 allows the scent to be removed without disconnection. FIG. 14 illustrates the scented branched tubing segment 400 employed with an anesthesia breathing circuit 402, shown in phantom. While a circular breathing circuit is shown, the scented branched tubing segment 400 could be used with a Mapleson or Bain type breathing circuit in a manner similar to that of the insertable tubing segment 300 as shown in FIG. 12.

The scented branched tubing segment 400 terminates in a first end coupling 404 and a second end coupling 406. The scented branched tubing segment 400 has a first branch 408, which is formed at least partially from a scented material, and a second branch 410, which is formed from a non-scented material. The scented branched tubing segment 400 also has a valve 412 located near the first end coupling 404. The valve 412 can be operated by use of a knob 414 to direct air flowing into the first end coupling 404 either through the first branch 408, as shown, or through the second branch 410. From either of the branches (408, 410), the air flows to the second end coupling 406, and thereafter into an inspiratory tube 416 of the anesthesia breathing circuit 402.

It should be appreciated that either scented connector pieces or elbows could be replaced with non-scented equivalents to create intermittent introduction of scent, subject to the limitation of the effectiveness of these scented elements discussed above and the need to allow access close to the patient to replace the scented element.

While the novel features of the present invention have been described in terms of particular embodiments and preferred applications, it should be appreciated by one skilled in the art that substitution of materials and modification of details obviously can be made without departing from the spirit of the invention.

What I claim is:

1. An improved anesthesia breathing circuit for delivery of anesthetic gas from an anesthesia delivery machine to a face mask configured to be worn by a patient, the anesthesia breathing circuit having,
an inspiratory tube for delivery of gas from the anesthesia delivery machine,
an expiratory tube for delivery of gases expired by the patient to the anesthesia delivery machine, and
means for connecting to the face mask so as to communicate between the face mask and the inspiratory tube and the expiratory tube,
the improvement comprising:
fabricating at least one of the inspiratory tube and the means for connecting to the face mask, at least in part, from a scented material.

2. The improved anesthesia breathing circuit of claim 1 wherein the means for connecting to the face mask further comprises:
a terminal region of the expiratory tube that extends beyond and communicates with the inspiratory tube.

3. The improved anesthesia breathing circuit of claim 2 wherein the means for connecting to the face mask further comprises:
an elbow connecting the face mask to the terminal region of the expiratory tube.

4. The improved anesthesia breathing circuit of claim 3 wherein the elbow is formed from a scented material.

5. The improved anesthesia breathing circuit of claim 3 wherein at least a portion of the inspiratory tube is fabricated from a scented material.

6. The improved anesthesia breathing circuit of claim 1 wherein the means for connecting to the face mask further comprises:
a Y-shaped connector piece which is connected to the inspiratory tube and to the expiratory tube and which communicates therewith.

7. The improved anesthesia breathing circuit of claim 6 wherein the means for connecting to the face mask further comprises:
an elbow connecting the face mask to the connector piece.

8. The improved anesthesia breathing circuit of claim 7 wherein the elbow is formed from a scented material.

9. The improved anesthesia breathing circuit of claim 7 wherein the inspiratory tube is corrugated and at least a portion of the corrugated inspiratory tube is fabricated from a scented material.

10. The improved anesthesia breathing circuit of claim 1 wherein the improvement further comprises:
means for substantially reducing the transfer of scent from said scented material to the gas delivered to the patient.

11. The improved anesthesia breathing circuit of claim 10 wherein said means for substantially reducing the transfer of scent from said scented material further comprises:
the inspiratory tube having at least a segment formed from a corrugated tube which is scented over a portion having an in-service elongated length L_{E} and which can be longitudinally compressed to an extent that the corrugated tubing has grooves that are reduced to an effective groove length λ approaching zero; and
means for maintaining the elongated length L_{E} of said scented portion compressed to an extent that the grooves are reduced to an effective groove length λ approaching zero.

12. The improved anesthesia breathing circuit of claim 11 wherein said means for maintaining the elongated length L_{E} of said scented portion compressed further comprises:
a pair of retaining elements that engage the ends of said scented portion; and
means for constraining said retaining elements so as to limit the separation therebetween.

13. The improved anesthesia breathing circuit of claim 12 wherein said means for constraining said retaining elements further comprises:
a clip which can be engaged with said pair of retaining elements when said scented portion is collapsed to bring said pair of retaining elements to a reduced separation, said clip being configured to maintain said pair of retaining elements at said reduced separation when engaged therewith.

14. The improved anesthesia breathing circuit of claim 12 wherein said retaining elements are a pair of rings and said means for constraining said retaining elements further comprises:
a turnscrew which threadably engages said rings and is configured to draw said pair of rings to a reduced separation and maintain them at said reduced separation.

15. The improved anesthesia breathing circuit of claim 10 wherein said means for substantially reducing the transfer of scent from said scented material to the gas delivered to the patient further comprises:
a removable portion of the inspiratory tube which is fabricated from a scented material and attaches to a permanent portion of the inspiratory tube which in turn connects to the means for connecting to the face mask.

16. The improved anesthesia breathing circuit of claim 15 wherein the permanent portion of the
inspiratory tube terminates at a standard inspiratory tube anesthesia machine coupling which is configured to sealably engage a standard anesthesia inspiratory port of the anesthesia delivery machine,
further wherein said removable portion terminates in a first end coupling, which is configured to sealably engage the standard anesthesia inspiratory port of the anesthesia delivery machine, and a second end coupling, which is configured to sealably engage the standard inspiratory tube anesthesia machine coupling of the permanent portion.

17. The improved anesthesia breathing circuit of claim 15 wherein said removable portion further comprises:
a first branch formed, at least in part, from a scented material;
a second branch formed from an unscented material; and
a valve for selectively communicating either of said first branch or said second branch with said first end coupling and said second end coupling.

18. An improved anesthesia breathing circuit for delivery of anesthetic gas from an anesthesia delivery machine to a face mask configured to be worn by a patient, the anesthesia breathing circuit having,
an inspiratory tube for delivery of gas from the anesthesia delivery machine,
an expiratory tube for delivery of gases expired by the patient to the anesthesia delivery machine, and
means for connecting to the face mask so as to communicate between the face mask and the inspiratory tube and the expiratory tube,
the improvement comprising:
fabricating at least one of the inspiratory tube and the means for connecting to the face mask, at least in part, from a scented material; and
means for substantially reducing the transfer of scent from said scented material to the gas delivered to the patient.

19. The improved anesthesia breathing circuit of claim 18 wherein said means for substantially reducing the transfer of scent from said scented material further comprises:
the inspiratory tube having at least a segment formed from a corrugated tube which is scented over a portion having an in-service elongated length L_{E} and which can be longitudinally compressed to an extent that the corrugated tubing has grooves that are reduced to an effective groove length λ approaching zero; and
means for maintaining the elongated length L_{E} of said scented portion compressed to an extent that the grooves are reduced to an effective groove length λ approaching zero.

20. An improved anesthesia breathing circuit for delivery of anesthetic gas from an anesthesia delivery machine to a face mask configured to be worn by a patient, the anesthesia breathing circuit having,
an inspiratory tube for delivery of gas from the anesthesia delivery machine,
an expiratory tube for delivery of gases expired by the patient to the anesthesia delivery machine, and
means for connecting to the face mask so as to communicate between the face mask and the inspiratory tube and the expiratory tube,
the improvement comprising:
a removable portion of the inspiratory tube which is fabricated from a scented material and attaches to a permanent portion of the inspiratory tube which in turn connects to the means for connecting to the face mask,
wherein removal of said removable portion of the inspiratory tube substantially reduces the transfer of scent from said scented material to the gas delivered to the patient.
